(19) United States
(12) Patent Application Publication
(10) Pub. No.: US 2007/0104910 A1
(43) Pub. Date: May 10, 2007

(54) DEVICE AND METHOD OF REDUCING WRINKLES

(76) Inventors: Jannette Danielian, Sherman Oaks, CA (US); George A. Danielian, Sherman Oaks, CA (US)

Correspondence Address: ADVANTIA LAW GROUP, 9035 SOUTH 1300 EAST, SUITE 200, SANDY, UT, 84094, US

(21) Appl. No.: 11/163,967

(22) Filed: Nov. 4, 2005

(51) Int. Cl. B32B 33/00

(52) U.S. Cl. 428/40.1

(57) ABSTRACT

A device for reducing wrinkles by holding the wrinkle apart, including a core that substantially resists compressive forces applied by a wrinkle; an adhesive layer attached to the core to adhesively secure the core to the wrinkle; a cover layer attached to the core on a side opposite from a side that is attached to the adhesive layer; and a release liner attached to the adhesive layer, wherein the adhesive liner does not damage the adhesive layer when reduced from the adhesive layer. Also disclosed is a method of reducing wrinkles by holding the wrinkle apart, including stretching a wrinkle apart by pulling on opposite sides of the wrinkle in a direction that is substantially orthogonal to the wrinkle, applying the device, and allowing it to remain applied for a substantial amount of time such that the wrinkle is reduced.

### BACKGROUND OF THE INVENTION

The present invention relates to devices and methods of reducing wrinkles, specifically devices and methods of reducing wrinkles by maintaining skin in a stretched position.

In U.S. Patent Application Publication 2004/0138699 Lish discloses beauty tape, which will be an opaque or clear tape for the face with seven pieces that are designed for seven areas of the face that are prone to wrinkles. It will be made out of a hypoallergenic and breathable material. Consisting of piece number 1 will be for the forehead. 2 and 3 will be for the temples. 4 will be for the top lip, 5 for below bottom lip, 6 on right cheek, next to the nose and mouth, and 7 will be placed on the left cheek next to the nose and mouth. It will be a very fine textured tape with small holes.

In U.S. Pat. No. 3,949,741 Hofmann discloses a method and appliance for reducing facial wrinkles. In the method, a pressure-sensitive adhesive appliance is tightly applying to wrinkle prone areas of the human face in such a manner that the skin under the appliance is placed in a flattened and smoothed configuration. The appliance remains in place for at least four hours and then is reduced in a manner to strip dead skin cells from the skin. These steps are repeated a plurality of times over a long period of time. The appliance transmits moisture at least equal to that transmitted by facial skin of a human and is comprised of a film and a pressure-sensitive adhesive coating. The film has a tensile strength and an ultimate elongation consistent with flattening and smoothening the skin. The adhesion between the adhesive and the film is greater than the adhesion between the adhesive and the skin.

Fausone, in U.S. Pat. No. 4,239,037, discloses the face lifting equipment includes a hairpiece with comb for holding the hairpiece on top of a woman's head. A strip of material including VELCRO is secured at its central portion to the underside of the hairpiece and its top surface made accessible by bending up opposite portions or wing portions of the hairpiece. Elastic bands terminating in adhesive elements include VELCRO pads for connection to the VELCRO on the strip. The adhesive pads adhere to the woman's skin adjacent to her temples to pull upwardly on the skin and thus reduce wrinkles and the like. The use of VELCRO provides an infinate number of positions for securement of the VELCRO pads so that a very fine control of the tension in the elastic members can be realized.

In U.S. Pat. No. 2,392,377 Golding discloses a wrinkle restraining device for application to a selected area of a persons face comprising a hollow suction pad having a form contoured to fit the selected area, said pad defined by a relatively thin flexible wall terminating in a flange forming edge adapted to engage the surface of the skin under treatment to seal the pad interior from the exterior atmosphere, said pad considered as a whole having sufficient rigidity to maintain its configuration and having sufficient elasticity to recover its form when distorting forces thereon are reduced, and a body of sponge-like-rubber flexible porous material permanently adhering thereto and completely filling the pad and terminating in a skin engaging surface substantially coinciding with the plane containing said edge of the pad whereby the surface presented to the skin will be continuous from edge to edge and composed largely of the porous material surrounded by the edge of the relatively rigid pad.

In U.S. Pat. No. 2,001,862 to Battey, what is disclosed is a tissue support for treating facial lines, comprising a tissue-supporting member adapted to exert opposing forces on opposite sides of a facial line whereby to hold the lined tissue in a stretched condition conversely of said line, an adhesive adapted to secure said member to the facial tissues, the member being formed of a moisture absorbing material having a capacity for shrinkage upon drying, and a moisture-resisting coating on the outer surface of said member whereby upon loss of moisture incident to drying upon the wearer's face the said member is caused to warp concavely toward the face.

U.S. Design Pat. No. D423,140 discloses the ornamental design for a pore cleansing strip.

What is needed is a device and/or method for reducing wrinkles that solves one or more of the problems described herein and/or one or more problems that may come to the attention of one skilled in the art upon becoming familiar with this specification.

### SUMMARY

The present invention has been developed in response to the present state of the art, and in particular, in response to the problems and needs in the art that have not yet been fully solved by currently available devices and methods of reducing wrinkles. Accordingly, the present invention has been developed to provide a device for reducing wrinkles by holding the winkle apart, including a core that substantially resists compressive forces applied to a wrinkle, an adhesive layer attached to the core to adhesively secure the core to the wrinkle, a cover layer attached to the core on a side opposite from a side that is attached to the adhesive layer, and a release liner attached to the adhesive layer, wherein the adhesive liner does not damage the adhesive layer when reduced from the adhesive layer.

The adhesive layer may include a section that does not adhere to the wrinkle. The core may include at least one side not covered by the cover layer or the adhesive layer.

According to another embodiment, this invention includes a device for reducing wrinkles by holding the wrinkle apart, wherein the device consists only of a core that substantially resists compressive forces applied by a wrinkle, an adhesive layer attached to the core to adhesively secure the core to the wrinkle, a cover layer attached to the core on a side opposite from a side that is attached to the adhesive layer, and a release liner attached to the adhesive layer, wherein the adhesive liner does not damage the adhesive layer when reduced from the adhesive layer.

The adhesive layer may include a section that does not adhere to the wrinkle. The core may include at least one side that is not covered by the cover layer or the adhesive layer.

According to yet another embodiment, this invention includes a method for reducing wrinkles by holding the wrinkle apart, including the steps of: stretching a wrinkle apart by pulling on opposite sides of the wrinkle in a direction that is substantially orthogonal to the wrinkle; applying a device to the wrinkle such that the device is applied to hold the wrinkle apart, wherein the device includes a core that substantially resists compressive forces applied by a wrinkle, an adhesive layer attached to the core to adhesively secure the core to the wrinkle, and a cover layer attached to the core on a side opposite from a side that is attached to the adhesive layer; and allowing the device to remain applied to the wrinkle for a substantial amount of time such that the wrinkle is reduced.

According to this method, the adhesive layer may include a section that does not adhere to the wrinkle, and at least two sections that do adhere to the wrinkle, and the device may be applied such that the sections that do adhere to the wrinkle are applied to opposite sides of the wrinkle. Further, the core may include at least one side that is not covered by the cover layer or the adhesive layer. The device may further include a release liner attached to the adhesive layer, wherein the release liner does not damage the adhesive layer when reduced from the adhesive layer, and the method may further include the step of reducing the release liner.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a side plan view of a device for reducing wrinkles according to one embodiment of the present invention;

FIG. 2 illustrates a device for reducing wrinkles as used according to one embodiment of the present invention; and

FIG. 3 illustrates a side plan view of a device for reducing wrinkles according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

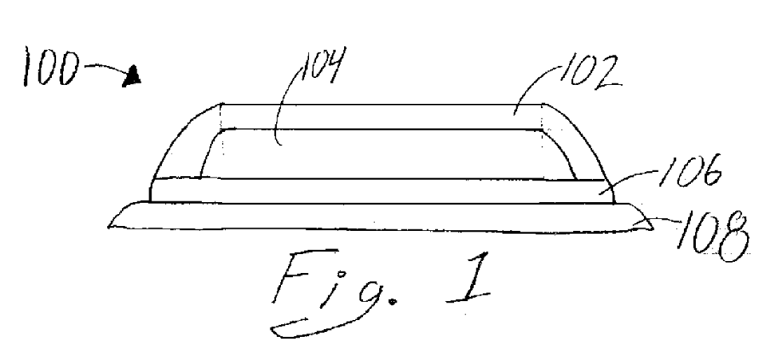

FIG. 1 illustrates a side plan view of a device 100 for reducing wrinkles according to one embodiment of the present invention. According to this embodiment, the device 100 includes an cover layer 102, a core 104, an adhesive layer 106, and a release liner 108.

The cover layer 102 may be a material for covering the device 100. The cover layer 102 may be designed to have a color that is nearly the same as a skin color. In another embodiment the cover layer 102 may include designs. The cover layer 102 may be made of any material capable of at least partially covering the device 100 such as woven fibers, non-woven fibers, laminated layer, polymer, composite, gel, and so forth. The cover layer 102 may be gas permeable such that gasses are allowed to pass through this cover layer 102.

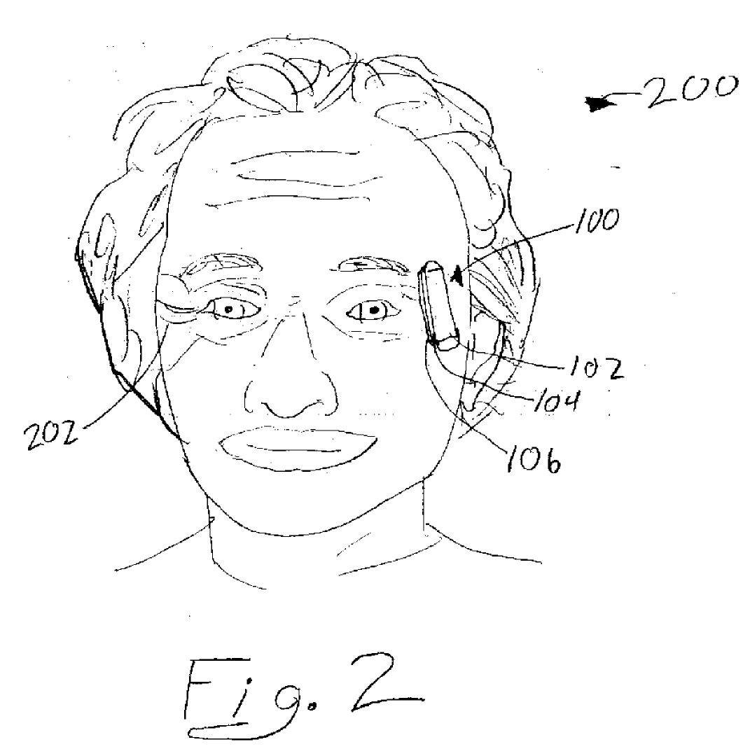

The core 104 is designed to resist compressive forces. That is, according to one embodiment, the device 100 is designed to hold the skin such that a wrinkle 202 (see FIG. 2) is stretched. Turning to FIG. 2, it is shown that according to one embodiment, the device 100 may be placed substantially orthogonal to a wrinkle 202 such that the opposite sides of the wrinkle are held apart by the device 100. As such, the core 104 is designed such that it is capable of resisting forces placed on the device 100 by the wrinkles 202 after the device 100 is applied to the wrinkle 202.

The core 104 may be made of any material capable of resisting the forces of a wrinkle 202. Such material may include, for example, plastics, polymers, composites, metals, glasses, woods, minerals, and so forth. The core 104 may be of any size such that it is capable of resisting the forces of a wrinkle 202. The core 104 does not need to extend to the extreme ends of the device 100. According to one embodiment, however, the core 104 extends to the ends of the device 100.

The adhesive 106 is designed to hold the device 100 to the opposite sides of the wrinkle 202. Any adhesive known in the art may be used. Attached to the adhesive layer 106 is a release liner 108. The release liner 108 is designed to protect the adhesive layer 106 until the device 100 is ready to be used. The release liner 108 is further designed such that it does not substantially damage the adhesive layer 106 when the release liner is reduced from the device 100. Release liners 108 may include, for example, a coated substrate such as a plastic coated paper, a coated plastic, and so forth. The release liner 108 may be continuous (one piece) or more than one piece. That is, there may be a division in the release liner 108 that allows a part of the release liner 108 to be reduced from the device 100 at a time. For example, the release liner 108 may be split such that half of the release liner 108 may be reduced, and the device 100 applied to one side of a wrinkle 202 (See FIG. 2) before the second half of the release liner 108 is reduced. The release liner 108 may also be cut such that it is substantially the same size as the adhesive layer 106. In another embodiment, the release liner 108 is slightly larger than the adhesive layer 106 such that the extra portions of the release liner 108 may serve to assist in the reduction of the release liner 108 from the adhesive layer 106. That is, in this embodiment, the user may grip the portion of the release liner 108 that extends beyond the ends of the adhesive layer 106 to reduce the release liner 108.

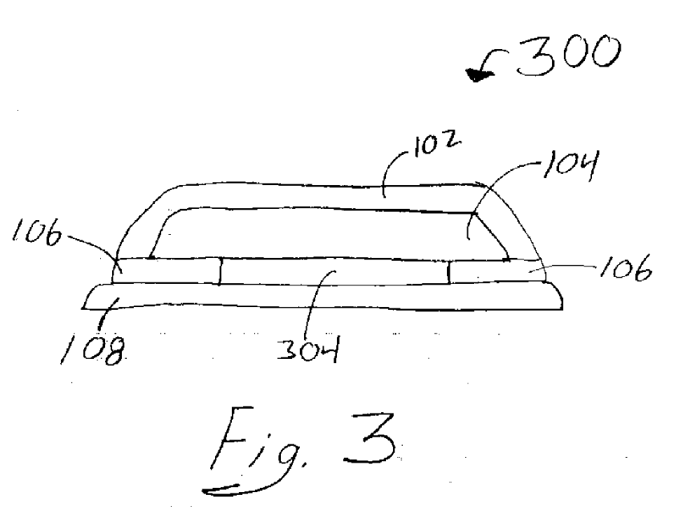

Turning now to FIG. 3, the device 300 according to one embodiment of the present invention is illustrated. According to this embodiment, the adhesive layer 106 is divided into more than one section. The center section 304 of the release liner 106 may be a section that is not designed to adhere to the wrinkle as tightly as are the adhesive sections of the adhesive layer 106. This center section 304 may include a void, that is, there would be no layer attached to the core 104 on the center section 304. In another embodiment, the center section 304 may include a substrate that is substantially the same thickness as the adhesive layer 106, but not designed to adhere to the wrinkle 202 to the same degree that the adhesive layer 106 is designed to adhere to the wrinkle 202. According to another embodiment, the center section 304 may include a medicated substrate. For example, the center section 304 may include a wrinkle-reducing cosmetic, lotion, moisturizer, or so forth.

According to another embodiment of the present invention, disclosed is a method of reducing wrinkles 202 by holding the wrinkle 202 apart. The method includes the step of stretching a wrinkle 202 apart by pulling on opposite sides of the wrinkle 202 in a direction that is substantially orthogonal to the wrinkle 202. A device 100 according to any of the embodiments disclosed herein is applied to the wrinkle 202 such that the device 100 is applied to hold the wrinkle 202 apart. The method also includes the step of allowing the device to remain applied to the wrinkle for a substantial amount of time such that the wrinkle is reduced. The amount of time that is necessary may include at least about 1 hour, or at least about 6 hours, or at least about 8 hours; and less than about 2 days, or less than about 1 day, or less than about 12 hours. According to one embodiment, the device 100 is allowed to remain applied to the wrinkle 200 overnight.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A device for reducing wrinkles by holding the winkle apart, including:
a core that substantially resists compressive forces applied by a wrinkle;
an adhesive layer attached to the core to adhesively secure the core to the wrinkle;
a cover layer attached to the core on a side opposite from a side that is attached to the adhesive layer; and
a release liner attached to the adhesive layer, wherein the adhesive liner does not damage the adhesive layer when reduced from the adhesive layer.

2. The device of claim 1, wherein the adhesive layer includes a section that does not adhere to the wrinkle.

3. The device of claim 1, wherein the core includes at least one side not covered by the cover layer or the adhesive layer.

4. A device for reducing wrinkles by holding the wrinkle apart, consisting of:
a core that substantially resists compressive forces applied by a wrinkle;
an adhesive layer attached to the core to adhesively secure the core to the wrinkle;
a cover layer attached to the core on a side opposite from a side that is attached to the adhesive layer; and
a release liner attached to the adhesive layer, wherein the adhesive liner does not damage the adhesive layer when reduced from the adhesive layer.

5. The device of claim 4, wherein the adhesive layer includes a section that does not adhere to the wrinkle.

6. The device of claim 4, wherein the core includes at least one side not covered by the cover layer or the adhesive layer.

7. A method for reducing wrinkles by holding the wrinkle apart, comprising:
stretching a wrinkle apart by pulling on opposite sides of the wrinkle in a direction that is substantially orthogonal to the wrinkle;
applying a device to the wrinkle such that the device is applied to hold the wrinkle apart, wherein the device includes
a core that substantially resists compressive forces applied by a wrinkle;
an adhesive layer attached to the core to adhesively secure the core to the wrinkle; and
a cover layer attached to the core on a side opposite from a side that is attached to the adhesive layer; and
allowing the device to remain applied to the wrinkle for a substantial amount of time such that the wrinkle is reduced.

8. The method for reducing wrinkles of claim 7, wherein the adhesive layer includes a section that does not adhere to the wrinkle, and at least two sections that do adhere to the wrinkle, and the device is applied such that the sections that do adhere to the wrinkle are applied to opposite sides of the wrinkle.

9. The method for reducing wrinkles of claim 7, wherein the core includes at least one side not covered by the cover layer or the adhesive layer.

10. The method for reducing wrinkles of claim 7, wherein the device further includes a release liner attached to the adhesive layer, wherein the release liner does not damage the adhesive layer when reduced from the adhesive layer, and further comprising the step of reducing the release liner.
